(19) United States
(12) Patent Application Publication
(10) Pub. No.: US 2026/0061890 A1
(43) Pub. Date: Mar. 5, 2026

(54) MODULAR VEHICLE SEATING ASSEMBLY

(71) Applicant: Ford Global Technologies, LLC, Dearborn, MI (US)

(72) Inventors: Macit Aktas, Windsor (CA); Luke Gajda, Royal Oak, MI (US); Johnathan Andrew Line, Northville, MI (US); Linh Ngoc Doan, Belleville, MI (US); Thomas J. Susko, Saint Clair Shores, MI (US)

(73) Assignee: Ford Global Technologies, LLC, Dearborn, MI (US)

(21) Appl. No.: 18/966,729

(22) Filed: Dec. 3, 2024

Related U.S. Application Data
(60) Provisional application No. 63/689,260, filed on Aug. 30, 2024.

(51) Int. Cl. B60N 2/02; B60N 2/12; B60N 2/18

(52) U.S. Cl. CPC B60N 2/02246; B60N 2/12; B60N 2/1807

(57) ABSTRACT

A vehicle seating assembly includes a seat base operably coupled to a vehicle floor and a lift assembly operably coupled with the seat base, wherein the lift assembly is vertically operable between an engaged position and a disengaged position to vertically adjust a forward portion of the seat base when in the engaged position. The lift assembly includes a base bracket extending between the seat base and the vehicle floor, a first terminal bracket disposed on a first end of the base bracket, a second terminal bracket disposed on a second end of the base bracket, a drive shaft extending between the first terminal bracket and the second terminal bracket, and an articulating bracket operably coupled to the drive shaft, wherein the articulating bracket is configured to translate along the drive shaft to adjust the forward portion of the seat base when the lift assembly is in the engaged position.

### CROSS-REFERENCE TO RELATED APPLICATIONS

This application claims priority to U.S. 63/689,260, filed on Aug. 30, 2024, entitled “MODULAR VEHICLE SEATING ASSEMBLY,” the disclosure of which is hereby incorporated herein by reference in its entirety.

### FIELD OF THE DISCLOSURE

The present disclosure generally relates to a seating assembly for a vehicle and more particularly to a lift assembly for the vehicle seating assembly.

### BACKGROUND OF THE DISCLOSURE

Vehicle seating assemblies generally include seating structures configured to support the static and dynamic weight of an occupant during travel. The seating structures are often complex and assembled piece by piece at a manufacturing site.

### SUMMARY OF THE DISCLOSURE

According to a first aspect of the present disclosure, a vehicle seating assembly includes a seat base operably coupled to a vehicle floor including a forward portion and a rearward portion, and a lift assembly operably coupled with the seat base, wherein the lift assembly is vertically operable between an engaged position and a disengaged position to vertically adjust the forward portion of the seat base when in the engaged position. The lift assembly includes a base bracket extending between the seat base and the vehicle floor, wherein the base bracket includes a first end and a second end, a first terminal bracket disposed on the first end of the base bracket, and a second terminal bracket disposed on the second end of the base bracket, a drive shaft extending between the first terminal bracket and the second terminal bracket, and an articulating bracket operably coupled to the drive shaft, wherein the articulating bracket is configured to translate along the drive shaft to adjust the forward portion of the seat base when the lift assembly is in the engaged position.

Embodiments of the first aspect of the present disclosure can include any one or a combination of the following features:
a rail assembly including rails supported by the vehicle floor and slides operably coupled with the seat base, wherein the slides slidably engage with the rails along a longitudinal direction to adjust a position of the seat base, and a lateral support structure positioned on opposing sides of the seat base, wherein the lateral support structures extend between the forward portion and the rearward portion of the seat base proximate the rail assembly;
the base bracket is positioned on an interior portion of the lateral support structure and is operably coupled to a connector link positioned on an exterior portion of the lateral support structure;
the first end of the base bracket defines an opening and the second end defines a curvature portion, and wherein the connector link includes a first curved end and a second curved end;
a first coupling joint extends through the opening of the base bracket to engage with the first curved end of the connector link and a second coupling joint extends along the curvature portion of the base bracket to engage with the second curved end of the connector link;
the vehicle seating assembly of claim 4, wherein a first coupling joint extends through the opening of the base bracket to engage with the first curved end of the connector link and a second coupling joint extends along the curvature portion of the base bracket to engage with the second curved end of the connector link;
the articulating bracket includes a first end and a second end, and wherein the first end is operably coupled to the drive shaft and the second end defines an aperture configured to receive the second coupling joint;
a coupling bracket is coupled to the rail assembly positioned between the base bracket and the connector link, wherein the coupling bracket defines an aperture configured to receive an end of the first coupling joint to secure the lift assembly;
an anchor bracket coupled to the second end of the base bracket, wherein the first terminal bracket is coupled to the anchor bracket;
the lift assembly includes a motor and a motor shaft, and wherein the motor shaft extends from an end of the motor to engage with the lead nut;
the motor and the motor shaft are disposed in a motor housing, and wherein the motor housing is operably coupled to the articulating bracket of the lift assembly;
the seat base is operable between a seated position and a reclined position;
the reclined position includes decreasing a second distance between the seatback and the vehicle floor;
a lead nut threadably engaged with the drive shaft, wherein the lead nut is configured to translate along the drive shaft between the first terminal bracket and the second terminal bracket; and
the seat base is operably coupled to a rotation assembly, and wherein the rotation assembly is configured to adjust the rearward portion of the seat base.

According to a second aspect of the present disclosure, a vehicle seating assembly includes a seat base operably coupled to a vehicle floor including a forward portion and a rearward portion. The seat base is operable between a seated position and a reclined position, a lift assembly operably coupled with the seat base frame, wherein the lift assembly is configured to vertically adjust the seat base relative to the vehicle floor when the seat base operates between the seated position and the reclined position. The lift assembly includes a base bracket including a body and an articulating bracket operably coupled to the forward portion of the seat base, wherein the seat base is configured to translate along a length of the body of the base bracket to adjust the seat base between the seated position and the reclined position.

Embodiments of the second aspect of the present disclosure can include any one or a combination of the following features:
a first terminal bracket and a second terminal bracket disposed on the body of the base bracket, a drive shaft extending between the first terminal bracket and the second terminal bracket, wherein the drive shaft includes a first end and a second end, and a lead nut threadably engaged with the drive shaft, wherein the lead nut is configured to translate along the drive shaft from the first terminal bracket to the second terminal to vertically adjust the forward portion of the seat base; and the first terminal bracket defines a channel configured to receive the first end of the drive shaft, and wherein the second terminal bracket defines an aperture to receive the second end of the drive shaft such that the drive shaft extends along the body of the base bracket.

According to a third aspect of the present disclosure, a modular seating assembly for a vehicle includes a seat base frame operably coupled to a vehicle floor, a seat base including a forward portion and a rearward portion, wherein the seat base is operable between a seated position and a reclined position, a lift assembly operably coupled with the seat base frame, wherein the lift assembly is configured to adjust the seat base a distance when the seat base operates between the seated position and the reclined position. The lift assembly including a motor assembly disposed proximate an underside of the seat base in a central location between the forward portion of the seat base and the vehicle floor, wherein the motor assembly includes a motor and a motor shaft extending from the motor, an articulating bracket operably coupled to the motor assembly configured to vertically adjust the forward portion of the seat base relative to the vehicle floor, the forward portion of the seat base being adjusted away from the vehicle floor when the lift assembly is engaged.

Embodiments of the second aspect of the present disclosure can include any one or a combination of the following features:
a base bracket having a first end and a second end, wherein the base bracket extends between the forward portion of the seat base and the vehicle floor, and wherein the drive shaft extends along the base bracket, a first terminal bracket disposed on the first end of the base bracket, and a second terminal bracket disposed on the second end of the base bracket, wherein the lead nut is configured to translate along the drive shaft between the first terminal bracket and the second terminal bracket when the seat base transitions between the seated position and the reclined position; and
the distance of the seat base between the forward portion and the vehicle floor positions the seat base at an angle relative to the vehicle floor when the seat base is in the reclined position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a partial side perspective view of a vehicle seating assembly within an interior compartment of a vehicle;

FIG. 2 is a side perspective view of a vehicle seating assembly including a seat base pivotably coupled with a seatback;

FIG. 3 is an exploded view of a seat base and a seat base frame for a vehicle seating assembly including a cover stock, seat cushion assembly, suspension assembly, lift assembly, and a seat pan;

FIG. 4 is a side perspective view of a seat pan including a suspension assembly disposed in an intermediate open area of the seat pan;

FIG. 5 is a side elevational view of a seat pan including a rearward support defining an arcuate portion;

FIG. 6 is a side perspective view of a seat base frame including a lift assembly;

FIG. 7A is a side perspective view of a lift assembly including a motor and a pair of motor shafts extending from the motor and opposing lift mechanisms operably coupled to the motor shafts;

FIG. 7B is a side perspective view of a lift assembly with a motor housing and an articulating bracket removed;

FIG. 8 is an exploded view of a portion of a lift assembly including opposing lift mechanisms having a base bracket, drive shaft, lead nut, and an articulating bracket;

FIG. 9 is a side perspective view of a vehicle seating assembly including a seat pan engaged with a front cross beam and a rear cross beam;

FIG. 10A is a partial side perspective view of a lift mechanism of a lift assembly operably coupled to a seat base frame when the seat base is in a seated position;

FIG. 10B is a partial side perspective view of a lift mechanism of a lift assembly operably coupled to a seat base frame when the seat base is in a reclined position;

FIG. 11A is a side perspective view of a vehicle seating assembly including a lift assembly operably coupled to a seat base frame when the vehicle seating assembly is in a seated position;

FIG. 11B is a side perspective view of a vehicle seating assembly including a lift assembly operably coupled to a seat base frame when the vehicle seating assembly is in a reclined position; and

FIG. 12 is a block diagram of a control arrangement for a vehicle seating assembly.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

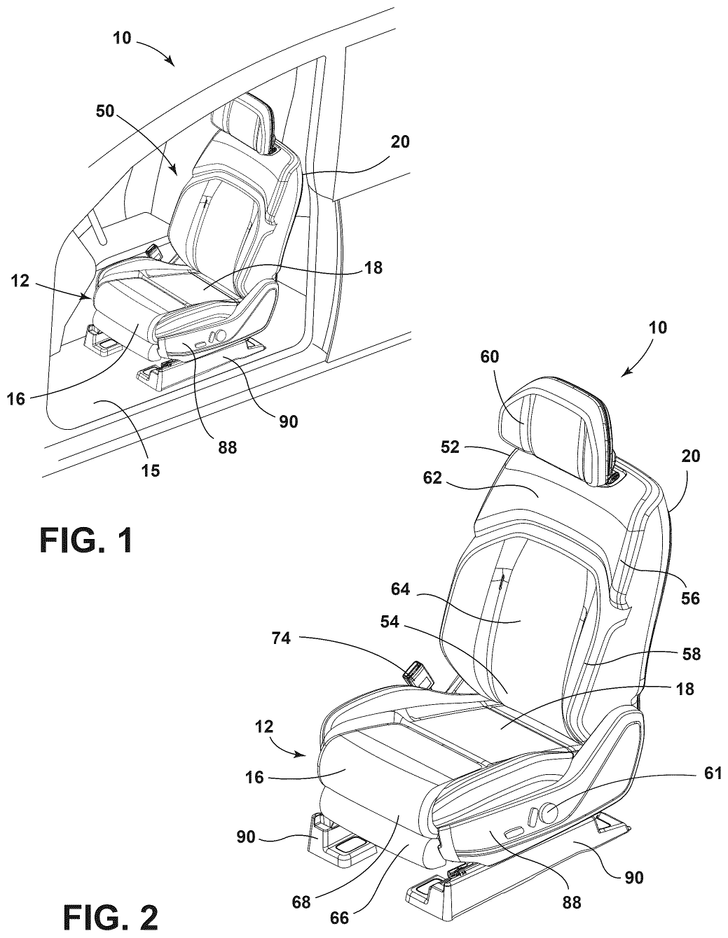

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a lift assembly for a vehicle seating assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

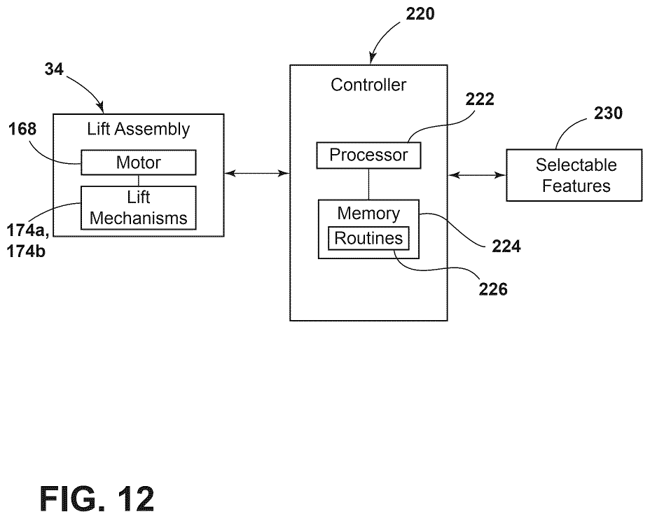

Referring to FIGS. 1-12, a reference numeral 10 generally designates a seating assembly for a vehicle 11 that includes a seat base 12 operably coupled to a seat base frame 14. The seat base 12 is operably coupled to a vehicle floor 15 and includes a forward portion 16 and a rearward portion 18. A seatback 20 is rotatably coupled to the seat base 12 proximate the rearward portion 16. A seat cushion assembly 22 is coupled to a seat pan 24. The seat pan 24 includes at least one hooked tab 26 disposed on an underside 28 of the seat pan 24. The seat pan 24 also includes a rearward support 30 defining an arcuate portion 32. A lift assembly 34 is operably coupled with the seat base 12 and is vertically operable between an engaged position and a disengaged position to vertically adjust the forward position 16 of the seat base 12 when in the engaged position. The lift assembly 34 includes a base bracket 36 extending between an underside of the seat base 12 and the vehicle floor 15. The base bracket 36 includes a first end 38a and a second end 38b. An upper terminal bracket 40 is disposed on the first end 38a of the base bracket 36 and a lower terminal bracket 42 is disposed on the second end 38b of the base bracket 36. A drive shaft 44 extends between the upper terminal bracket 40 and the lower terminal bracket 42. A lead nut 46 is threadably engaged with the drive shaft 44 and is configured to translate along the drive shaft 44. An articulating bracket 48 is operably coupled to the lead nut 46. The articulating bracket 48 is configured to translate along the driver shaft 44 via the lead nut 46 to adjust the forward portion 16 of the seat base 12 when the lift assembly 34 is in the engaged position.

Referring now to FIGS. 1, the vehicle 11 includes an interior compartment 50, which includes at least one seating assembly 10 for supporting passengers thereon. The vehicle 11 may be a sedan, a sport utility vehicle, a van, a truck, a crossover, other styles of wheeled motor vehicles, or other styles of vehicles. The vehicle 11 may be a manually operated vehicle (e.g., operated with a human driver), a fully autonomous vehicle (e.g., operated without a human driver), or a partially autonomous vehicle (e.g., operated with or without a human driver). Additionally, the vehicle 11 may be utilized for personal and/or commercial purposes, such as for ride-providing services (e.g., chauffeuring), transporting, and/or ride-sharing services.

Referring still to FIG. 1, as well as FIG. 2, the vehicle seating assembly 10 includes the seat base 12 having the forward portion 16 and the rearward portion 18, and the seatback 20 having a top portion 52 and a bottom portion 54. The rearward portion 18 of the seat base 12 is positioned proximate the bottom portion 54 of the seatback 20, such that the seatback 20 is pivotal relative to the rearward portion 18 of the seat base 12. The seatback 20 includes both an upper seatback 56 and a lower seatback 58. The vehicle seating assembly 10 includes a head restraint 60 that is disposed on the upper seatback 56. The head restraint 60 is moveable between forward and rearward positions to accommodate various sized heads of passengers, as well as different heights of passengers. The vehicle seating assembly 10 also includes controls 61 specifically configured to adjust an upper thoracic portion 62 of the upper seatback 56 or a lower lumbar portion 64 of the lower seatback 58.

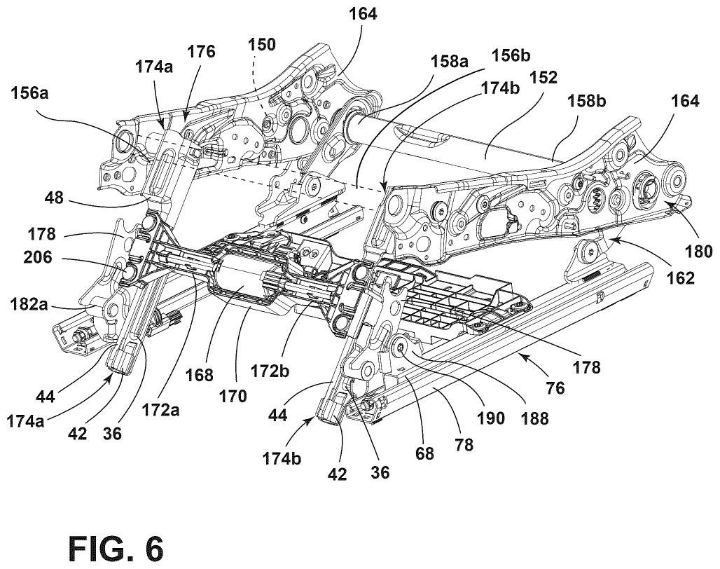

The vehicle seating assembly 10 may include a variety of comfort controls, including, for example, calf support 66, thigh support 68, and a pivot control that allows for pivoting movement of the seatback 20. Additionally, a receiver 74 for a tether assembly is disposed on the vehicle seating assembly 10 to secure the passenger when seated. In addition, the vehicle seating assembly 10 is suspended on a rail slide assembly 76 (FIG. 6) that allows movement of the vehicle seating assembly 10 in fore and aft directions relative to the vehicle 11. The rail slide assembly 76 includes rails 78 that may be secured on the vehicle floor 15. In various examples, the rail slide assembly 76 may be coupled to the vehicle floor 15 by one or more legs 81. The legs 81 may be coupled to the rails 78 of the rail slide assembly 76. Additionally, the rail slide assembly 76 includes slides 82 which may be operably coupled with the vehicle seating assembly 10, in particular, the seat base frame 14. The slides 82 are in sliding engagement with the rails 78. The slidable motion of the slides 82 relative to the rails 78 along a longitudinal direction are capable of adjusting the relative position of the seat base 12, the seatback 20, and the lift assembly 34 relative to the rail slide assembly 76 and/or the legs 81. Accordingly, a forward trim component and side trim pieces 88 may be disposed about the seat base 12 and base trim pieces 90 may be disposed about the seat base frame 14. The trim components cover the seat base frame 14 and structural components of the seat base 12, such as the rail slide assembly 76.

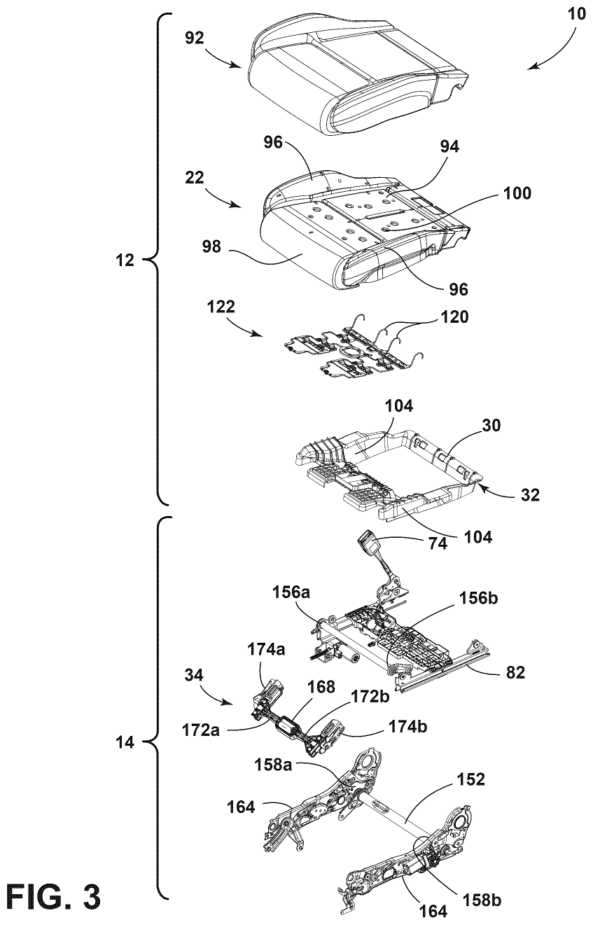

Referring to FIG. 3, the seat base 12 includes the seat cushion assembly 22 with a cover stock 92 disposed thereon. The cover stock 92 may include different varieties over different portions of the seat cushion assembly 22. The seat cushion assembly 22 of the seat base 12 includes a main cushion 94, seat side bolsters 96, and a thigh support cushion 98. The thigh support cushion 98 is configured to wrap over thigh support 68 to provide comfort while supporting the passenger's thighs. The main cushion 94 and/or side bolsters 96 may include a plurality of ventilation holes 100 configured to allow air to pass through the seat base 12. Accordingly, a climate control system may be provided in the seat base 12, which can draw air from, or blow air through, the seat cushion assembly 22 and cover stock 92.

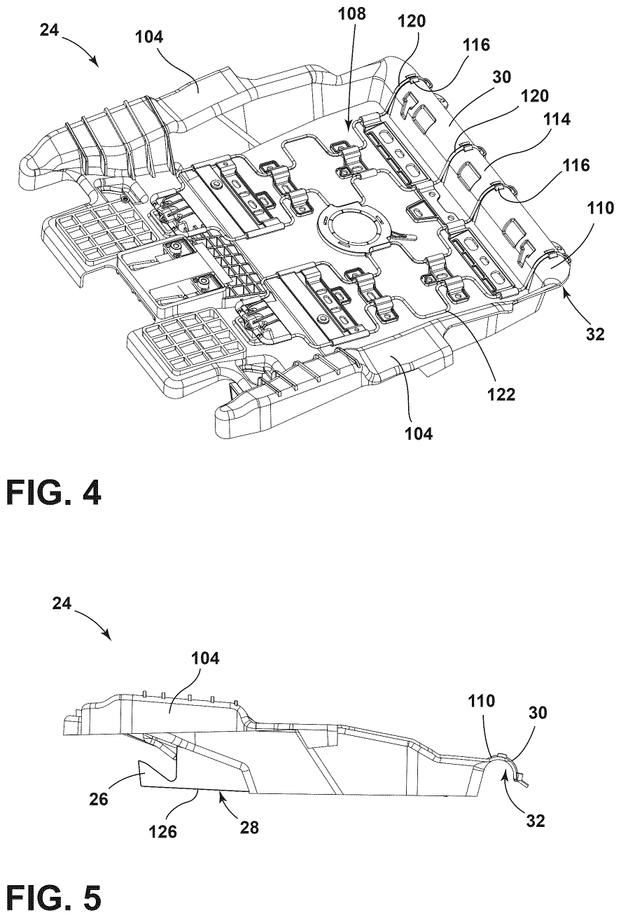

Referring still to FIG. 3, as well as FIGS. 4 and 5, the seat base 12 includes the seat pan 24 that is operably coupled with the seat base frame 14 and is positioned between the seat base frame 14 and the seat cushion assembly 22 with the cover stock 92 disposed thereon. The seat pan 24 may include side bolsters 104 that may be integrally formed with the seat pan 24 or may be attached thereto. The side bolsters 104 are configured to support and flex under stress to provide resiliency to the seat pan 24. Additionally, integrally forming the side bolsters 104 with the seat pan 24 increases the structural support for the passenger during ingress and/or egress from the seating assembly 10 as well as during jounce and abuse loading circumstances.

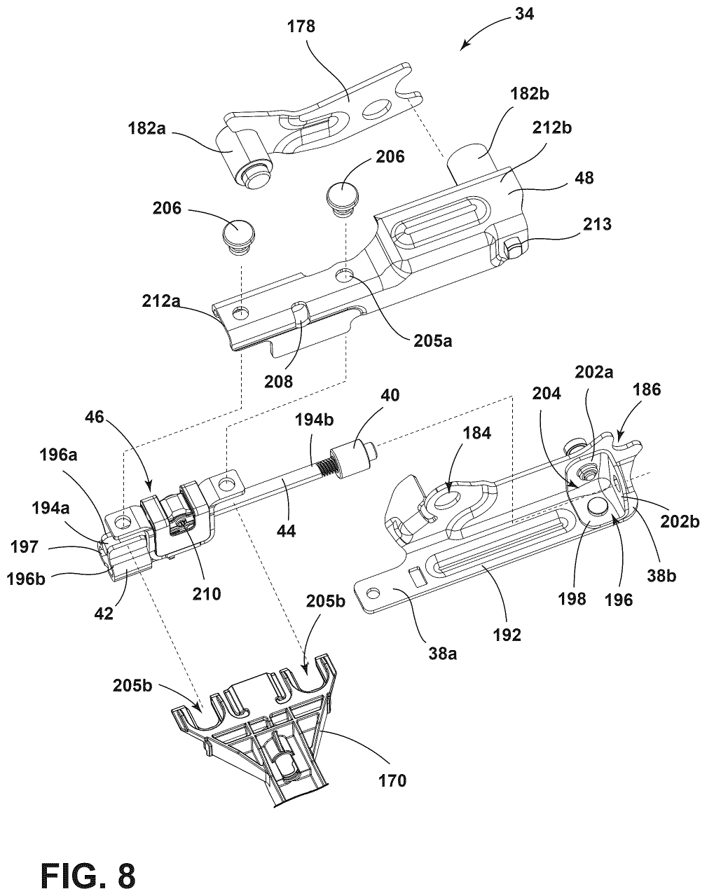

Referring still to FIGS. 3-5, the seat pan 24 further includes the rearward support 30 that, along with the side bolsters 104, at least partially defines an intermediate open area 108. The rearward support 30 of the seat pan 24 defines the arcuate portion 32 forming a rear engagement channel 110. The rearward support 30 may be configured to operably couple the seat pan 24, and consequently, the seat base 12, with the seat base frame 14, as is further described herein. A surface 114 of the rearward support 30 includes receiving notches 116 configured to receive hooks 120 of a suspension assembly 122. The suspension assembly 122 is disposed in the intermediate open area 108 of the seat pan 24. The suspension assembly 122 supports the seat cushion assembly 22 and the seat cover stock 92 and is configured to withstand both the static and dynamic loads associated with seated passenger travel. Additionally, the seat pan 24 includes a bottom wall 126 having the at least one hooked tab 26 extending therefrom in a vehicle-forward direction. In the illustrated configuration depicted in FIG. 8, there is a first hooked tab 26a and a second hooked tab 26b that are each forwardly extending hooked tabs 26. However, it will be understood that more or less forwardly-extending hook features may be contemplated. Accordingly, the hooked tabs 26 engage the seat base frame 14 to assist in coupling the seat base 12 to the seat base frame 14, as is further described herein.

Referring still to FIG. 3, as well as FIG. 6, the vehicle seating assembly 10 includes the seat base frame 14 that operably couples the seat base 12 to the vehicle floor 15. The seat base frame 14 includes a front cross beam 150 proximate to the thigh support 68 and a rear cross beam 152 proximate the bottom portion 54 of the seatback 20 when the vehicle seating assembly 10 is assembled. The front cross beam 150 includes a first end 156a and a second end 156b that engage the lift assembly 34 to assist in vertically displacing the seat base 12. In other words, the engagement of the front cross beam 150 with the lift assembly 34 assists in directing the forward portion 16 of the seat base 12 in an upward and a downward direction. The rear cross beam 152 of the seat base frame 14 includes a first end 158a and a second end 158b and may be configured to engage with a rotation assembly 162 to adjust the rearward portion 18 of the seat base 12 in the generally upward or downward direction independent of the movement of the forward portion 16 of the seat base 12. Additionally, the seat base frame 14 may include lateral support structures 164. The lateral support structures 164 are positioned on opposing sides of the seat base 12 and extend from the forward portion 16 to the rearward portion 18 of the seat base 12. Accordingly, the lateral support structures 164 are positioned proximate the rail slide assembly 76. As is further described herein, the lateral support structures 164 are configured to engage with the lift assembly 34 to assist in adjusting the direction of the seat base 12.

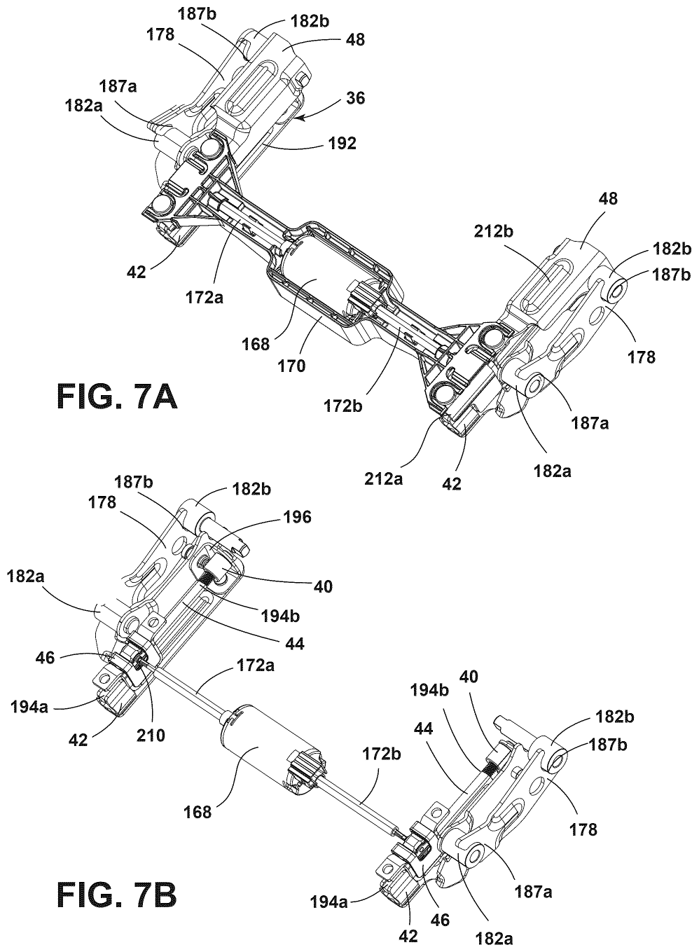

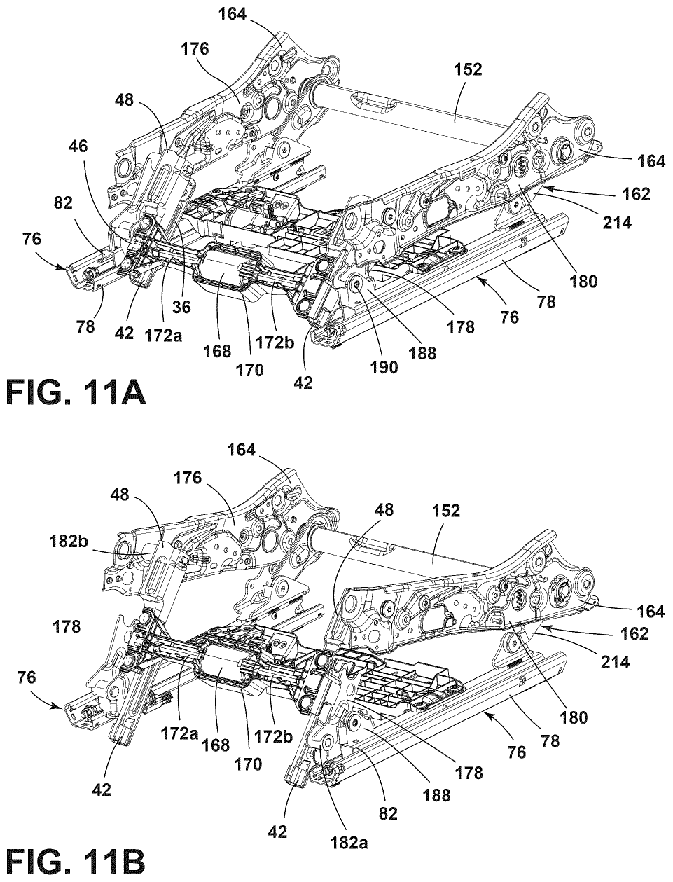

Referring still to FIG. 6, as well as FIGS. 7A-8, the vehicle seating assembly 10 is operable between a seated position (see FIG. 11A) and a reclined position (see FIG. 11B) with the assistance of the lift assembly 34. The lift assembly 34 may be a linear lift mechanism configured to adjust the forward portion 16 of the seat base 12. The lift assembly 34 is operable between the engaged position configured to adjust the forward portion 16 of the seat base 12 in the upward direction towards the reclined position or the disengaged position configured to adjust the forward portion 16 of the seat base 12 in the downward direction towards the seated position. In various examples, the lift assembly 34 includes a motor 168 disposed in a motor housing 170. The motor 168 is located directly below the forward portion 16 of the seat base 12. More specifically, the motor 168 may be centrally located beneath the forward portion 16 of the seat base 12 relative to the vehicle floor 80. In other words, the motor 168 is centrally disposed proximate the underside of the forward portion 16 of the seat base 12. A pair of motor shafts 172a, 172b extend from opposing ends of the motor 168 and are disposed in the motor housing 170. The motor shafts 172a, 172b extend from each end of the motor 168 to engage with opposing lift mechanisms 174a, 174b that are each positioned proximate the rails 78 of the rail slide assembly 76, respectively, and are each engaged with an interior portion 176 of the lateral support structures 164. Each of the opposing lift mechanisms 174a, 174b include the base bracket 36 that extends from the underside 28 of the seat pan 24 proximate the forward portion 16 to the vehicle floor 15. Accordingly, each of the base brackets 36 are positioned proximate and non-parallel, non-perpendicular to a portion of the rails 78 of the rail slide assembly 76. However, it is contemplated that the base bracket 36 may be positioned in various configurations relative to the rail slide assembly 76, including parallel to or perpendicular to the rail slide assembly 76.

The base bracket 36 may be coupled to a connector link 178 positioned on an exterior portion 180 of the lateral support structures 164 via a first coupling joint 182a and a second coupling joint 182b. In various examples, the base bracket 36 of the opposing lift mechanisms 174a, 174b may include an opening 184 on the first end 38a configured to receive one end of the first coupling joint 182a and a curved portion 186 on the second end 38b configured to engage with the second coupling joint 182b. The connector link 178 may include a first curved end 187a and a second curved end 187b. When the first coupling joint 182a extends through the opening 184 of the base bracket 36, the first coupling joint 182a may engage with the first curved end 187a of the connector link 178. Additionally, when the second coupling joint 182b extends along the curved portion 186 of the base bracket 36, the second coupling joint 182b may engage with the second curved end 187b of the connector link 178 to assist in securing and positioning the lift mechanisms 174a, 174b to the seat base 12.

Additionally, a coupling bracket 188 may be coupled to the rail slide assembly and may be positioned between the base bracket 36 and the connector link 178. The coupling bracket 188 may include an aperture 190 in which the first coupling joint 182a may extend therethrough to engage with the connector link 178. The coupling bracket 188 is configured to assist in further securing the opposing lift mechanisms 174a, 174b, and consequently the lift assembly 34, to the seat base.

Referring still to FIGS. 6-8, each of the opposing lift mechanisms 174a, 174b also include a drive shaft 44 extending along a body 192 of the base bracket 36. The drive shaft 44 can define threads that are engaged by a lead nut 46. The threads defined by the drive shaft 44 can facilitate the movement of the lead nut 46 along the drive shaft 44, as well as maintain a position of the lead nut 46 when rotation of the drive shaft 44 is stopped. Accordingly, the lead nut 46 engages the drive shaft 44 such that a position of the lead nut 46 along the drive shaft 44 is adjusted when the motor 168 is activated. A first end 194a of the drive shaft 44 may be coupled to the lower terminal bracket 42 and a second end 194b of the drive shaft 44 may be coupled to the upper terminal bracket 40. Accordingly, the lower terminal bracket 42 is disposed at the first end 38a of the base bracket 36 and the upper terminal bracket 40 is disposed at the second end 38b of the base bracket 36.

The lower terminal bracket 42 may include a body 196a having a base 196b configured to be coupled to the first end 38a of the base bracket 36. A top portion of the lower terminal bracket 42 defines a narrow channel 197 configured to receive the first end 194a of the drive shaft 44. Accordingly, the lower terminal bracket 42 may be broader proximate the base 196b as compared to the top portion. The narrower profile of the top portion of the lower terminal bracket 42 allows the lower terminal bracket 42 to align with the body 192 of the base bracket 36 without extending beyond the body 196a. Accordingly, an end of the articulating bracket 48 may be positioned overtop the lower terminal bracket 43 when the seat base 12 is in the seated position.

The upper terminal bracket 40 may be disposed on the second end 38b of the base bracket 36. The upper terminal bracket 40 may be generally cylindrical, however, the upper terminal bracket 40 may be configured to be generally another shape. A through-hole aperture is defined by the upper terminal 40 and is configured to receive the second end 194b of the drive shaft 44. Additionally, the upper terminal bracket 40 may be disposed on the second end 38a of the base bracket 36 or may be coupled to an anchor bracket 196. Accordingly, when the upper terminal bracket 40 is coupled to the anchor bracket 196, the second end 194b of the drive shaft 44 is configured to extend along the same plane as the first end 194a such that the drive shaft 44 is positioned parallel to the base bracket 36 but does not abut or engage the body 192 of the base bracket 36. Accordingly, the anchor bracket 196 is coupled to the second end 38b of the base bracket 36. Additionally, the anchor bracket 196 includes a body 198 having a base 200 that is coupled to the second end 38b of the body 192 of the base bracket 36. Extending from the base 200 of the anchor bracket 196 are sidewalls 202a, 202b that are perpendicular to one another. The base 200 and sidewalls 202a, 202b of the anchor bracket 196 partially define a space 204 in which the upper terminal bracket 40 is disposed. The space 204 provides for ease of access to the upper terminal bracket 40 and the drive shaft 44 during manufacturing or assembly.

Additionally, in various examples, an articulating bracket 48 is disposed overtop the opposing lift mechanisms 174a, 174b. The articulating bracket 48 includes apertures 205a configured to align with corresponding openings 205b defined by ends of the motor housing 170. Once aligned, fasteners 206 are received within the apertures 205a and the openings 205b, respectively, to secure the motor housing 170, and consequently the motor 168 and motor shafts 172a, 172b, to the opposing lifting mechanisms 174a, 174b. Accordingly, the articulating bracket 48 is configured to translate longitudinally along the body 192 of the base bracket 36 when the motor 168 is activated. For example, the articulating bracket 48 includes an opening 208 configured to receive an end of the motor shaft 172a. The end of the motor shaft 172a engages with a drive opening 210 defined by the lead nut 46. When the motor 168 is activated, the motor shaft 172a rotates to adjust a position of the lead nut 46.

Referring still to FIGS. 6-8, in various examples, the articulating bracket 48 includes a first end 212a proximate to and engaged with the lead nut 46 and a second end 212b proximate the underside 28 of the seat pan 24. The second end 212b of the articulating bracket 48 defines apertures 213 configured to receive the second coupling joint 182b. As such, when the seat base 12 operates between the seated position and the reclined position the engagement of the articulating bracket 48 with the second coupling joint 182b assists in adjusting the distance of the seat base 12. In other words, as the lead nut 46 translates along the drive shaft 44 from the lower terminal bracket 42 to the upper terminal bracket 40 when the lift assembly 34 is moving towards the engaged position, the articulating bracket 48 engages with the second coupling joint 182b to move in a longitudinal direction towards the seat base 12 to adjust the distance of the seat base 12.

Referring still to FIGS. 6-8, the rearward portion 18 of the seat base 12 may be adjusted similar to the forward portion 16 of the seat base 12. In various examples, the first end 158a of the rear cross beam 152 may be operably coupled to a bracket of the rotation assembly 162 and the second end 158b of the rear cross beam 152 may be operably coupled to a toothed portion 214 of the rotation assembly 162. The rotation assembly 162 may be described as a rack-and-pinion assembly. The rotation assembly 162 may include the toothed portion 214 (rack) of a second bracket coupled to the seat base frame 14 and a toothed wheel (pinion) coupled to an actuator. The toothed portion 214 of the second bracket and the toothed wheel may form a toothed interface. Actuation of the actuator may cause the toothed wheel to rotate so that the toothed portion 214 of the second bracket may move from a rest position to a deployed position. Accordingly, as the rotation assembly 162 adjusts from the rest position to the deployed position, the rearward portion 18 of the seat base 12 may adjust in a generally upward or downward direction independent of the forward portion 16. However, it is contemplated that the rear cross beam 152 may remain fixed or may not include the rotation assembly 162. Accordingly, the front cross beam 150 is positioned in a vehicle-forward location and the rear cross beam 152 is positioned in a vehicle-rearward location.

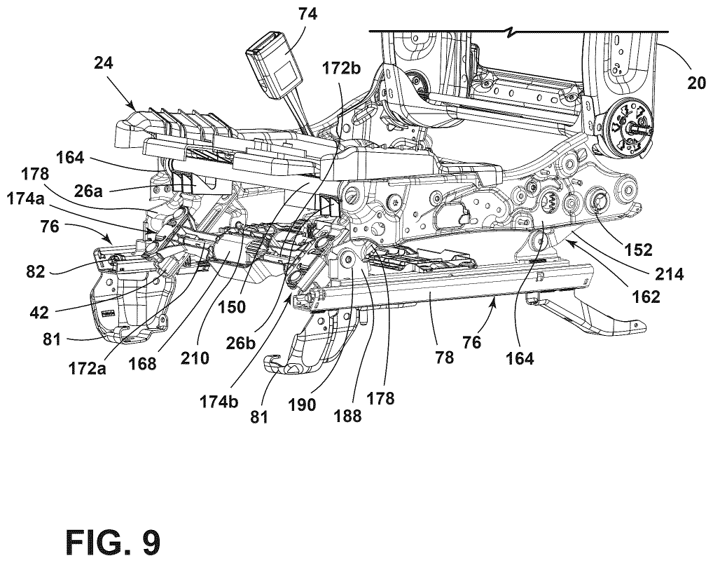

Referring now to FIG. 9, during manufacturing, the seat base 12 is prepared for engagement with the seat base frame 14. In particular, the first and second hooked tabs 26a, 26b of the seat pan 24 are configured to engage the front cross beam 150 to allow for rotation of the forward portion 16 of the seat base 12 about the front cross beam 150 in a generally downward direction towards the vehicle floor 15. As the seat pan 24 continues to rotate about the front cross beam 150 via the first and second hooked tabs 26a, 26b, the arcuate portion 32 of the rearward support 30 engages with the rear cross beam 152 of the seat base frame 14. In particular, as the seat base 12 is rotated downward into position, the rear engagement channel 110 of the rearward support 30 engages the rear cross beam 152. Once engaged, the lift assembly 34 of the seat base frame 14 may adjust the forward portion 16 of the seat base 12 and the rotation assembly 162 of the seat base frame 14 may adjust the forward portion 16 and the rearward portion 18 of the seat base 12, respectively, to, from, or between the seated position and the reclined position.

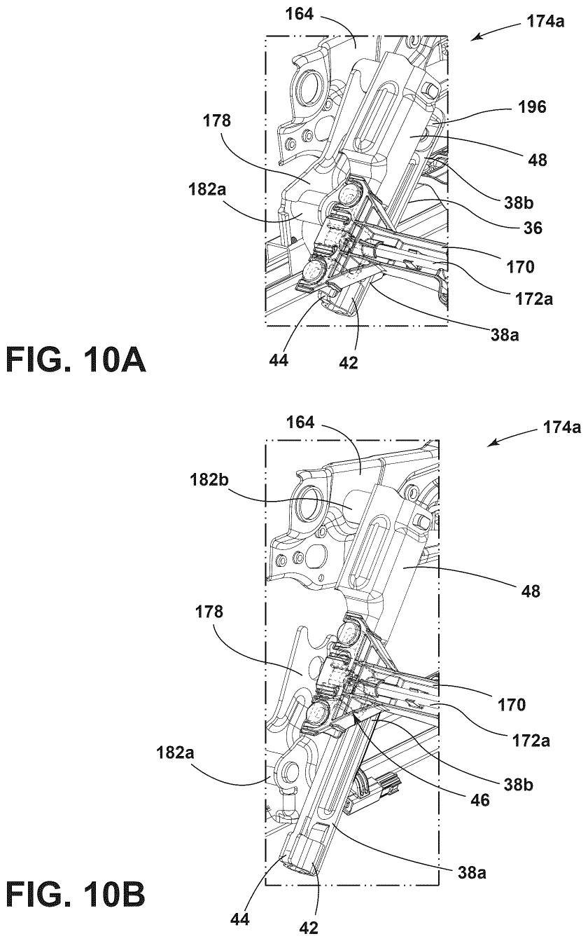

Referring to FIGS. 10A and 10B, the vehicle seating assembly 10 is capable of moving from the seated position toward the reclined position. The reclined position of the vehicle seating assembly 10 is intended for use when the vehicle 11 is in a stationary (i.e., non-moving) state. For example, while a transmission of the vehicle 11 is in a parked position. Accordingly, transitioning from the seated position to, from, and between the reclined position includes adjusting a position of the lead nut 46 along the drive shaft 44 of the lift mechanisms 174a, 174b such that the lead nut 46 moves away from the lower terminal bracket 42 towards the upper terminal bracket 40. Consequently, the translation of the lead nut 46 along the drive shaft 44 adjusts the position of the articulating bracket 48 to assist in adjusting the position of the seat base between the seated position and the reclined position. Accordingly, the angle between the lift assembly 34 and the rail slide assembly 76 may increase when the vehicle seating assembly 10 is transitioned from the seated position to the reclined position. Additionally, transitioning the vehicle seating assembly 10 from the seated position to the reclined position may include rotating the rotating assembly 162 proximate the rear cross beam 152 toward the rail slide assembly 76. Accordingly, the angle between the rotating assembly 162 and the rail slide assembly 76 may decrease when the vehicle seating assembly 10 is transitioned from the seated position to the reclined position.

Referring still to FIGS. 10A and 10B, as well as FIGS. 11A and 11B, in operation, when the vehicle seating assembly 10 is adjusted from the seated position to the reclined position, the motor 168 is activated. Activation of the motor 168 initiates rotation of the motor shafts 172a, 172b. For example, motor shafts 172a, 172b rotate in a clockwise direction to adjust the lifting mechanisms 174a, 174b in the upward direction relative to the vehicle floor 15. As the motor shafts 172a, 172b rotate, the lead nut 46 is configured to threadably translate along the drive shaft 44 from the lower terminal bracket 42 to the upper terminal bracket 40. Accordingly, the motor 168 and motor shafts 172a, 172b are adjusted in an upward direction perpendicular to and along with the lead nut 46. Consequently, as the lead nut 46 translates along the drive shaft 44, the articulating bracket 48 translates along the body 192 of the base bracket 36 engaging with the second coupling joint 182b to begin adjusting the seat base 12 in the upward direction. As the lead nut 46 reaches the upper terminal bracket 40, the articulating bracket 48 continues to adjust the seat base 12 in the upward direction via the second coupling joint 182b.

Similarly, when the vehicle seating assembly 10 is adjusted from reclined position to the seated position, the motor 168 is activated. Activation of the motor 168 initiates rotation of the motor shafts 172a, 172b. Accordingly, motor shafts 172a, 172b rotate in the counterclockwise direction to adjust the lifting mechanisms 174a, 174b in the downward direction relative to the vehicle floor 15. As the motor shafts 172a, 172b rotate, the lead nut 46 is configured to threadably translate along the drive shaft 44 from the upper terminal bracket 40 to the lower terminal bracket 42. Accordingly, the motor 168 and motor shafts 172a, 172b are adjusted in the downward direction perpendicular to and along with the lead nut 46 relative to the vehicle floor 15. Consequently, as the lead nut 46 translates along the drive shaft 44, the articulating bracket 48 translates along the body 192 of the base bracket 36 engaging with the second coupling joint 182b to begin adjusting the seat base 12 in the downward direction. As the lead nut 46 reaches the lower terminal bracket 42, the articulating bracket 48 continues to adjust the seat base 12 in the downward direction via the second coupling joint 182b.

Referring still to FIGS. 10A-11B, in the reclined position, an angular relationship between the seat base 12 and the vehicle floor 80 can be adjusted. A first distance between the forward portion 16 of the seat base 12 and the vehicle floor 15 may increase when the vehicle seating assembly 10 is transitioned from the seated position to the reclined position. Accordingly, a second distance between the rearward portion 18 of the seat base 12 and the vehicle floor 15 may decrease when the vehicle seating assembly 10 is transitioned from the seated position to the reclined position. In various examples, each component that is positioned between the seat base 12 and the vehicle floor 15 may be adjusted in its angular relationship relative to the vehicle floor 15 when the vehicle seating assembly 10 is transitioned to the reclined position.

When the vehicle seating assembly 10 transitions from the seated position toward the reclined position the first distance between the underside 28 of the forward portion 16 of the seat base 12 and the vehicle floor 80 may increase. In various examples, transitioning the vehicle seating assembly 10 from the seated position toward the reclined position may increase the first distance between the underside of the forward portion of the seat base and the vehicle floor 80 incrementally such that the seat base 12 is positioned at an angle relative to the vehicle floor 80. In other words, the first distance is the maximum distance that the forward portion 16 of the seat base 12 may be adjusted. Said another way, the first distance may position the seat base 12, at an angle of between about 19° to about 22° relative to the vehicle floor 80. However, prior to the seat base 12 reaching the first distance, the forward portion of the seat base 12 may be incrementally positioned between a range from an angle of approximately 1° to approximately 18° relative to the vehicle floor 80. Accordingly, the seat base 12 is lifted at a 2.5:1 to 3:1 ratio when reaching the first distance between the underside 28 of the seat pan 24 proximate the forward portion 16 of the seat base 12 and the vehicle floor 15. In other words, when the seat base 12 is positioned at the first distance, the seat base 12 may be at a maximum reclined position. Consequently, as the seat base 12 is adjusted from and/or between the first distance, the seatback 20 may rotate in the vehicle-rearward direction to the second distance between the bottom portion 54 of the seatback 20 and the vehicle floor 80. Accordingly, when the seating assembly 10 is in the seated position, the angle between the seat base 12 and the vehicle floor 15 may be generally zero.

Additionally, transitioning the vehicle seating assembly 10 from the seated position toward the reclined position can include rotating the seatback 20 in the vehicle-rearward direction from the seated position such that an angle of between about 30° and about 54° may be realized between the seatback 20 and the vehicle floor 15. As such, transitioning the vehicle seating assembly 10 from the seated position toward the reclined position can include decreasing the second distance between the rearward portion 18 of the seat base 12 and the vehicle floor 80.

When the vehicle seating assembly 10 is in the reclined position via the lift assembly 34, a neutral positioning capability may be achieved. The neutral position of the vehicle seating assembly 10 may simulate a posture that minimizes gravitational stress on the body, thereby further reducing strain on the spine and promoting optimal weight distribution. To achieve this, the lift assembly 34 may be adjusted with additional articulation points and degrees of freedom, allowing for adjustment of the seat base 12 and the seatback 20 angles.

Referring to FIG. 10, the vehicle seating assembly 10 may include a controller 220 that has a processor 222, such as a microprocessor, memory 224, and other digital and/or analog control circuitry. Instructions or routines 226 are stored in the memory 224 and executable by the processor 222. The controller 220 is in communication with a user interface, which may include a display, such as a touch screen with use inputs and output, or other selectable feature 230 (e.g., buttons, switches, knobs, etc.). The passenger or user may input a selection into the user interface regarding the vehicle seating assembly 10 positioning between the seated position and the reclined position. The input is communicated to the controller 220, which may then activate the motor 168.

The controller 220 may include the routine 226 for managing the transition between the seated position and the reclined position of the vehicle seating assembly 10. When the passenger interacts with the selectable features 230, the controller 220 may activate the lift assembly 34 positioned proximate the underside 28 of the seat pan 24. The controller 220 may then coordinate the movement of the opposing link mechanisms 174a, 174b by the motor 168, including the rotation of the lead nut 46 along the drive shaft 44. Simultaneously, the controller 220 may adjust the seatback 20 angle, rotating the seatback 20 in a vehicle-rearward direction.

Use of the present device and system may provide for a variety of advantages. For example, vehicle seating assemblies are typically designed to meet a number of specifications that are dictated by their use within a passenger compartment of the vehicle 11. These specifications include, but are not limited to, spatial considerations within the passenger compartment, packaging of user-desired feature(s), and balancing user experience for a plurality of users within the passenger compartment (e.g., leg room). The vehicle seating assembly 10 of the present disclosure is operable in the reclined position of the vehicle seating assembly 10 which may decrease a number of pressure points and/or an intensity of pressure points for a user seated in the vehicle seating assembly 10 while providing a more ergonomically comfortable arrangement than a conventional reclined position where the seatback 20 may be moved relative to the seat and the vehicle floor 80 in an isolated manner. The reclined position of the vehicle seating assembly 10 of the present disclosure may place the seatback 20 in a reclined position relative to the vehicle floor 80 and/or the seat. Additionally, the reclined position of the vehicle seating assembly 10 of the present disclosure can place the forward portion 16 of the seat base 12 in a reclined position relative to the vehicle floor 80 when compared to the seated position.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle seating assembly, comprising:
a seat base operably coupled to a vehicle floor including a forward portion and a rearward portion; and
a lift assembly operably coupled with the seat base, wherein the lift assembly is vertically operable between an engaged position and a disengaged position to vertically adjust the forward portion of the seat base when in the engaged position, the lift assembly including:
a base bracket extending between the seat base and the vehicle floor, wherein the base bracket includes a first end and a second end;
a first terminal bracket disposed on the first end of the base bracket and a second terminal bracket disposed on the second end of the base bracket;
an actuator operably coupled to the base bracket;
a drive shaft operably coupled to the actuation, wherein the drive shaft extends between the first terminal bracket and the second terminal bracket; and
an articulating bracket operably coupled to the drive shaft, wherein the articulating bracket is configured to translate along the drive shaft via the actuator to adjust the forward portion of the seat base when the lift assembly is in the engaged position.

2. The vehicle seating assembly of claim 1, further comprising:
a rail assembly including rails supported by the vehicle floor and slides operably coupled with the seat base, wherein the slides slidably engage with the rails along a longitudinal direction to adjust a position of the seat base; and
a lateral support structure positioned on opposing sides of the seat base, wherein the lateral support structures extend between the forward portion and the rearward portion of the seat base proximate the rail assembly.

3. The vehicle seating assembly of claim 2, wherein the base bracket is positioned on an interior portion of the lateral support structure and is operably coupled to a connector link positioned on an exterior portion of the lateral support structure.

4. The vehicle seating assembly of claim 3, wherein the first end of the base bracket defines an opening and the second end defines a curvature portion, and wherein the connector link includes a first curved end and a second curved end.

5. The vehicle seating assembly of claim 4, wherein a first coupling joint extends through the opening of the base bracket to engage with the first curved end of the connector link and a second coupling joint extends along the curvature portion of the base bracket to engage with the second curved end of the connector link.

6. The vehicle seating assembly of claim 5, wherein the articulating bracket includes a first end and a second end, and wherein the first end is operably coupled to the drive shaft and the second end defines an aperture configured to receive the second coupling joint.

7. The vehicle seating assembly of claim 5, wherein a coupling bracket is coupled to the rail assembly positioned between the base bracket and the connector link, wherein the coupling bracket defines an aperture configured to receive an end of the first coupling joint to secure the lift assembly.

8. The vehicle seating assembly of claim 1, further comprising:
an anchor bracket coupled to the second end of the base bracket, wherein the first terminal bracket is coupled to the anchor bracket.

9. The vehicle seating assembly of claim 1, wherein the lift assembly includes a motor and a motor shaft, and wherein the motor shaft extends from an end of the motor to engage with the lead nut.

10. The vehicle seating assembly of claim 9, wherein the motor and the motor shaft are disposed in a motor housing, and wherein the motor housing is operably coupled to the articulating bracket of the lift assembly.

11. The vehicle seating assembly of claim 1, wherein the seat base is operable between a seated position and a reclined position.

12. The vehicle seating assembly of claim 11, wherein the reclined position includes decreasing a second distance between the seatback and the vehicle floor.

13. The vehicle seating assembly of claim 11, further compromising:
a lead nut threadably engaged with the drive shaft, wherein the lead nut is configured to translate along the drive shaft between the first terminal bracket and the second terminal bracket.

14. The vehicle seating assembly of claim 1, wherein the seat base is operably coupled to a rotation assembly, and wherein the rotation assembly is configured to adjust the rearward portion of the seat base.

15. A vehicle seating assembly, comprising:
a seat base operably coupled to a vehicle floor including a forward portion and a rearward portion, wherein the seat base is operable between a seated position and a reclined position;
a lift assembly operably coupled with the seat base frame, wherein the lift assembly is configured to vertically adjust the seat base relative to the vehicle floor when the seat base operates between the seated position and the reclined position, the lift assembly including:
a base bracket including a body;
an actuator operably coupled to the base bracket; and
an articulating bracket operably coupled to the forward portion of the seat base, wherein the articulating bracket is configured to translate along a length of the body of the base bracket via the actuator to adjust the seat base between the seated position and the reclined position.

16. The vehicle seating assembly of claim 15, further comprising:
a first terminal bracket and a second terminal bracket disposed on the body of the base bracket;
a drive shaft extending between the first terminal bracket and the second terminal bracket, wherein the drive shaft includes a first end and a second end; and
a lead nut threadably engaged with the drive shaft, wherein the lead nut is configured to translate along the drive shaft from the first terminal bracket to the second terminal to vertically adjust the forward portion of the seat base.

17. The vehicle seating assembly of claim 16, wherein the first terminal bracket defines a channel configured to receive the first end of the drive shaft, and wherein the second terminal bracket defines an aperture to receive the second end of the drive shaft such that the drive shaft extends along the body of the base bracket.

18. A modular seating assembly for a vehicle, comprising:
a seat base frame operably coupled to a vehicle floor;
a seat base including a forward portion and a rearward portion, wherein the seat base is operable between a seated position and a reclined position;
a lift assembly operably coupled with the seat base frame, wherein the lift assembly is configured to adjust the seat base a distance when the seat base operates between the seated position and the reclined position, the lift assembly including:
a motor assembly disposed proximate an underside of the seat base in a central location between the forward portion of the seat base and the vehicle floor, wherein the motor assembly includes a motor and a motor shaft extending from the motor;
an articulating bracket operably coupled to the motor assembly configured to vertically adjust the forward portion of the seat base relative to the vehicle floor, the forward portion of the seat base being adjusted away from the vehicle floor when the lift assembly is engaged.

19. The modular seating assembly of claim 18, further comprising:
a base bracket having a first end and a second end, wherein the base bracket extends between the forward portion of the seat base and the vehicle floor, and wherein the drive shaft extends along the base bracket;
a first terminal bracket disposed on the first end of the base bracket; and
a second terminal bracket disposed on the second end of the base bracket, wherein the lead nut is configured to translate along the drive shaft between the first terminal bracket and the second terminal bracket when the seat base transitions between the seated position and the reclined position.

20. The modular seating assembly of claim 18, wherein the distance of the seat base between the forward portion and the vehicle floor positions the seat base at an angle relative to the vehicle floor when the seat base is in the reclined position.
